(19) United States
(12) Patent Application Publication
(10) Pub. No.: US 2015/0307710 A1
(43) Pub. Date: Oct. 29, 2015

(54) HARDENER COMPOUND FOR EPOXY SYSTEM

(71) Applicant: DOW GLOBAL TECHNOLOGIES LLC, Midland, MI (US)

(72) Inventors: Michael J. Mullins, Houston, TX (US); Chao Zhang, Shanghai (CN); Jia wen Xiong, Shanghai (CN); Hongyu Chen, Shanghai (CN); Michael D. Read, Midland, MI (US); Nan-Rong Chiou, Midland, MI (US)

(73) Assignee: Dow Global Technologies LLC, Midland, MI (US)

(21) Appl. No.: 14/649,600

(22) PCT Filed: Dec. 12, 2012
(86) PCT No.: PCT/CN2012/086470

§ 371 Date: Jun. 4, 2015

(51) Int. Cl. C08L 83/06; C08G 77/00

(52) U.S. Cl. CPC C08L 83/06; C08G 77/80; C08L 2312/08

(57) ABSTRACT

Embodiments of the present disclosure include a hardener compound for curing with an epoxy resin, where the hardener compound includes a copolymer having a first constitutional unit of the formula (I), a second constitutional unit of the formula (II), and a third constitutional unit of the formula (III), where each q, n and m is independently a positive integer; each b is independently selected from the group of 6, 8, 10 and 12; each Y is independently an organic group; and each R is independently selected from the group of a hydrogen, an organic group and a halogen. Embodiments of the present disclosure include an epoxy system that includes the hardener compound and an epoxy resin.

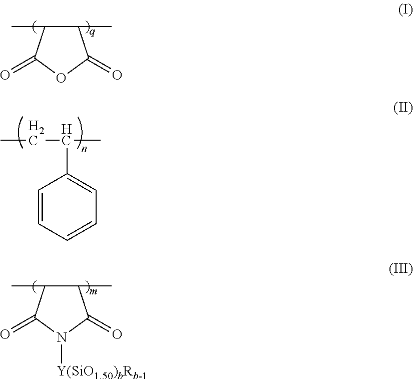

### FIELD OF DISCLOSURE

Embodiments of the present disclosure relate to a hardener compound for an epoxy system.

### BACKGROUND

Styrene/maleic anhydride copolymer (SMA) is an epoxy hardener that can provide for low Dk (dielectric constant)/Df (dielectric dissipation factor) epoxy laminates. Compared with other epoxy hardeners, the styrene in SMA is a non-polar structure that helps to lower the Dk/Df value, while the maleic anhydride (MAH) in SMA is an epoxy reactive group that does not leave secondary hydroxyl group after reaction with the epoxy.

SMA with a high styrene/MAH molar ratio is effective in achieving low Dk/Df values. These SMAs, however, have not been used for epoxy laminates because the cured epoxy has a glass transition temperature (Tg) that is typically too low to be useful. If, however, the Tg could be improved, SMA with a high styrene/MAH molar ratio would provide for a good hardener for epoxy laminates having a low Dk/Df value.

Therefore, there is a need for an SMA based hardener that can provide an epoxy laminate with an improved Tg value while maintaining a low Dk/Df value.

### SUMMARY

Embodiments of the present disclosure provide for a hardener compound for curing with an epoxy resin. The hardener compound of the present disclosure can be used with an epoxy resin to provide a cured epoxy with an improved Tg value and a low Dk/Df value, as discussed herein. Specifically, the hardener compound of the present disclosure is a copolymer having a first constitutional unit of the formula (I):

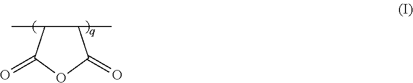

a second constitutional unit of the formula (II):

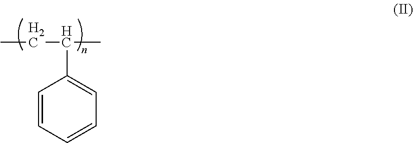

and a third constitutional unit of the formula (III):

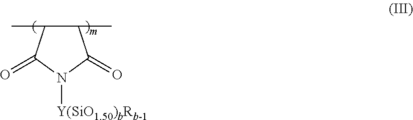

where each q, n and m is independently a positive integer; each b is independently selected from the group of 6, 8, 10 and 12; each Y is independently an organic group; and each R is independently selected from the group of a hydrogen, an organic group and a halogen. The organic group of each R can be independently selected from an aliphatic group, an aromatic group or a cycloaliphatic group. The organic group of each Y can be independently selected from an alkyl or an aromatic group.

In one embodiment, b can be 8, each R can be a phenyl group (Ph) and Y can be a —C₃H₆— group to provide the hardener compound of the present disclosure represented by formula (IV):

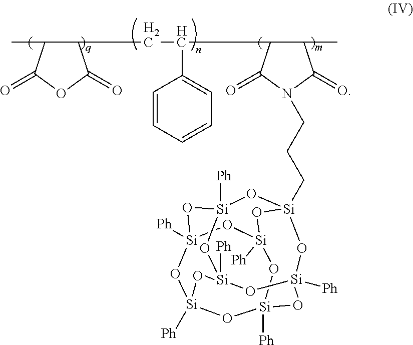

The first constitutional unit (formula (I)) of the hardener compound can constitute 0.5 weight percent (wt. %) to 50 wt. % based on the total weight of the hardener compound; the second constitutional unit (formula (II)) of the hardener compound can constitute 9 wt. % to 90 wt. % based on the total weight of the hardener compound; and the third constitutional unit (formula (III)) of the hardener compound can constitute 10 wt. % to 90 wt. % based on the total weight of the hardener compound, where the three constitutional units sum to provide 100 wt. % of the total weight of the hardener compound (i.e., wt. % of the first constitutional unit (formula (I))+wt. % of the second constitutional unit (formula (II))+wt. % of the third constitutional unit (formula (III)) equals 100 wt. % of the hardener compound).

The —Y(SiO_{1.5})_{b}R_{b-1} group of the third constitutional unit (formula (III)) can constitute 5 wt. % to 85 wt. % based on the total weight of the hardener compound. The positive integers for q, n and m sum to a value that is from 10 to no greater than 150 (e.g., 10≦(q+n+m)≦150), where each of q, n and m are positive integers (e.g., those greater than zero (0)) and a value of n/(q+m) is from 1 to 10. A molar ratio of combination of the first constitutional unit of the formula (I) and the third constitutional unit of the formula (III) to the second constitutional unit of formula (II) can be 1:1 to 1:10.

The present disclosure also provides a method of preparing the hardener compound for curing with an epoxy resin, where the method includes reacting a copolymer of styrene and maleic anhydride of the formula (V)

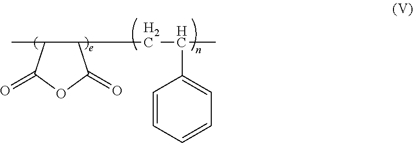

with an amino polyhedral oligomeric silsesquioxane of the formula (VI)

H₂N—Y(SiO_{1.5})_{b}R_{b-1} (VI)

under conditions effective to form the hardener compound of formula (VII):

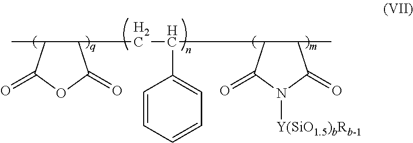

where each q, n and m is independently a positive integer, with e being the sum of q and m; each b is independently selected from the group of 6, 8, 10 and 12; each Y is independently an organic group; and each R is independently selected from the group of a hydrogen, an organic group and a halogen.

The present disclosure also provides for an epoxy system that includes an epoxy resin and a hardener compound as provided herein (e.g., the hardener compound of formula (VII)). For the various embodiments, the epoxy resin can be selected from the group of aromatic epoxy compounds, alicyclic epoxy compounds, aliphatic epoxy compounds, or a combination thereof. The present disclosure also includes an electrical laminate structure that includes a reaction product of the epoxy system that includes an epoxy resin and a hardener compound as provided herein (e.g., the hardener compound of formula (VII)). The present disclosure also includes a prepreg that includes the hardener compound provided herein.

The above summary of the present disclosure is not intended to describe each disclosed embodiment or every implementation of the present disclosure. The description that follows more particularly exemplifies illustrative embodiments. In several places throughout the application, guidance is provided through lists of examples, which examples can be used in various combinations. In each instance, the recited list serves only as a representative group and should not be interpreted as an exclusive list.

### DETAILED DESCRIPTION

The present disclosure provides a hardener compound for curing with an epoxy resin, a method of preparing the hardener compound for curing with an epoxy resin, and an epoxy system that includes the hardener compound and an epoxy resin. The epoxy system of the present disclosure provides for a cured epoxy system having desirable thermal properties and electrical properties. The desirable thermal properties can include a glass transition temperature (Tg) and degradation temperature, and the desirable electrical properties can include a dielectric constant (Dk) and a dissipation factor (Df).

For the various embodiments, the hardener compound is a copolymer formed with a styrene and maleic anhydride (SMA) copolymer modified with an amino polyhedral oligomeric silsesquioxane. Specifically, the SMA copolymer is modified by reacting a portion of the maleic anhydride groups in the SMA copolymer with the amino polyhedral oligomeric silsesquioxane to form the hardener compound. The hardener compound can be incorporated into epoxy systems to provide desirable thermal properties and electrical properties. Cured samples of the epoxy system that include the hardener compound and an epoxy resin display increases in Tg value, a low Dk value and low Df value as compared with cured epoxy systems formed with unmodified SMA. The cured epoxy system of the epoxy system of the present disclosure can be useful for electrical encapsulates, composites, electrical laminate structures, adhesives, prepregs and/or powder coatings.

As used herein, “constitutional units” refer to the smallest constitutional unit (a group of atoms comprising a part of the essential structure of a macromolecule), or monomer, the repetition of which constitutes a macromolecule, such as a polymer or a copolymer.

As used herein a “copolymer” is a polymer derived from more than one species of monomer. The copolymers provided herein (e.g., formulae W, V and VII) are shown as block copolymers as a general representation of the composition, but are not limited to these structures. As appreciated by one skilled in the art, the copolymers provided herein can be selected from an alternating copolymer, a periodic copolymer, a statistical copolymer, a random copolymer, a block copolymer or a combination thereof. As used herein, “a,” “an,” “the,” “at least one,” and one or more are used interchangeably. The term “and/or” means one, one or more, or all of the listed items. The recitations of numerical ranges by endpoints include all numbers subsumed within that range (e.g., 1 to 5 includes 1, 1.5, 2, 2.75, 3, 3.80, 4, 5, etc.).

As used herein, a “positive integer” is a positive integer (1, 2, 3, 4 . . . ) that does not include zero (0).

As used herein, an aliphatic group means a saturated or unsaturated linear or branched hydrocarbon groups that include alkyl, an alkenyl, an alkynyl or a combination thereof.

As used herein, cyclic group means a closed ring hydrocarbon group that includes an alicyclic group, an aromatic group, a heterocyclic group or a combination thereof.

As used herein, the term “organic group” means a hydrocarbon group that is classified as an aliphatic group, cyclic group, or a combination of aliphatic and cyclic groups. Examples of the organic group include, but are limited to, an alkyl group, such as methyl, ethyl, butyl, hexyl, isooctyl, an aromatic group, such as phenyl, cresyl, naphthyl, and alkaryl and aralkyl groups.

The term “alkyl group” means a saturated linear or branched monovalent hydrocarbon group including, for example, methyl, ethyl, n-propyl, isopropyl, t-butyl, amyl, heptyl, and the like.

The term “alkenyl group” means an unsaturated, linear or branched monovalent hydrocarbon group with one or more olefinically unsaturated groups (i.e., carbon-carbon double bonds), such as a vinyl group.

The term “alkynyl group” means an unsaturated, linear or branched monovalent hydrocarbon group with one or more carbon-carbon triple bonds.

The term “alicyclic group” means a cyclic hydrocarbon group having properties resembling those of aliphatic groups.

The term “aromatic group” or “aryl group” means a mono- or polynuclear aromatic hydrocarbon group.

The term “heterocyclic group” means a closed ring hydrocarbon in which one or more of the atoms in the ring is an element other than carbon (e.g., nitrogen, oxygen, sulfur, etc.).

The term “halogen” means a non-metal element of fluorine (F), chlorine (Cl), bromine (Br), iodine (I), or astatine (At).

As used herein, a compound is a substance composed of atoms or ions of two or more elements in chemical combination.

The hardener compound of the present disclosure includes a copolymer having a first constitutional unit of the formula (I):

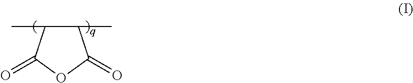

a second constitutional unit of the formula (II):

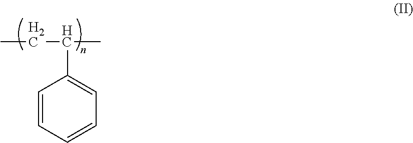

and a third constitutional unit of the formula (III):

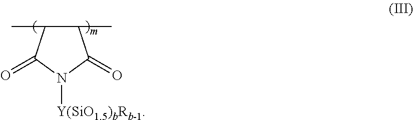

Each q, n and m is independently a positive integer. Each b is independently selected from the group of 6, 8, 10 and 12. Each Y is independently an organic group. Each R is independently selected from the group of a hydrogen, an organic group and a halogen.

Each of q, n and m is independently a positive integer. Examples of the positive integer for q, n and m includes positive integers from 1 to 80. Preferred values for q and m are from 1 to 40 and preferred values for n are from 10 to 80. For the various embodiments, the positive integer for q, n and m sum (e.g., q+n+m) to a value that is from 10 to no greater than 150 and a value of n/(q+m) is from 1 to 10. In addition, the sum of q+m is always equal to or less than the value of n. Preferred values of n are from 10 to 80, more preferable from 10 to 70, and most preferable from 10 to 65. Values for each of q and m can range from 1 to 40; more preferably from 2 to 30, and most preferably from 2 to 25.

The molar ratio of q to m can vary from 20:1 (q:m) to 1:20, more preferably in the range from 1:10 to 5:1, and most preferably in the range from 1:10 to 4:1.

Each Y is independently an organic group. Examples of the organic group for Y are selected from the group of an alkyl group and an aromatic group. As such, each Y can be independently selected from an alkyl group or an aromatic group.

Examples of the alkyl group for Y include, but are not limited to, aliphatic diradicals such as methylene, 1,2-ethylene, 1,1-ethylene, 1,3-propylene, 1,2-propylene, 1,4-butylene, 1,6-hexylene, 1,4-cyclohexylene, oxymethylene, and oxyethylene.

Examples of the aromatic group for Y include, but are not limited to, o-, m-, and p-phenylene, naphthylene isomers, and biphenylene isomers.

Each R is independently selected from the group of a hydrogen, an organic group and a halogen. Examples of the organic group for R are selected from the group of an aliphatic group, an aromatic group, or a cycloaliphatic group. As such, each R can be independently selected from an aliphatic group or a cyclic group.

Examples of the aliphatic group for R include, but are not limited to, saturated or unsaturated linear or branched hydrocarbon groups that include alkyl, an alkenyl, an alkynyl or a combination thereof.

Examples of the cyclic group for R include, but are not limited to, a closed ring hydrocarbon group that includes an alicyclic group, an aromatic group, a heterocyclic group or a combination thereof.

Examples of the halogen for R can be selected from the group of fluorine (F), chlorine (Cl), bromine (Br), or iodine (I).

For the hardener compound of the present disclosure, the weight percent (wt. %) of the first constitutional unit (formula (I)), the second constitutional unit (formula (II)) and the third constitutional (formula (III)) of the hardener compound adds up to 100 wt. %, where each of the first constitutional unit, the second constitutional unit and the third constitutional has a wt. % that is greater than 0 (e.g., 0.1 wt. %). For the embodiments, the first constitutional unit (formula (I)) constitutes 0.5 wt. % to 50 wt. % based on a total weight of the hardener compound. In an addition embodiment, the first constitutional unit (formula (I)) constitutes 5 wt. % to 20 wt. % based on a total weight of the hardener compound. For the embodiments, the second constitutional unit (formula (II)) constitutes 9 wt. % to 90 wt. % based on a total weight of the hardener compound. For the embodiments, the third constitutional unit (formula (III)) constitutes 10 wt. % to 90 wt. % based on a total weight of the hardener compound. For the embodiments, the —Y(SiO_{1.5})_{b}R_{b-1} group of the third constitutional unit (formula (III)) constitutes 5 wt. % to 85 wt. % based on the total weight of the hardener compound. For the embodiments, the third constitutional unit (formula (III)) constitutes 20 wt. % to 90 wt. % based on a total weight of the hardener compound. Most preferably, the third constitutional unit (formula (III)) constitutes 30 wt. % to 85 wt. % based on a total weight of the hardener compound.

The hardener compound of the present disclosure can be prepared in a variety of ways. For example, the hardener compound can be prepared by reacting a copolymer of styrene and maleic anhydride (SMA copolymer) of the formula (V)

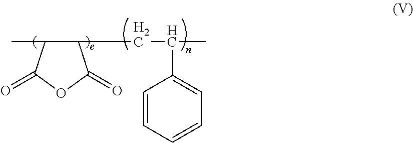

with an amino polyhedral oligomeric silsesquioxane of the formula (VI)

H₂N—Y(SiO_{1.5})_{b}R_{b-1} (VI)

under conditions effective to form the hardener copolymer of formula (VII):

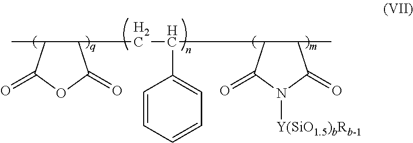

where each q, n and m is independently a positive integer, with e being the sum of q and m; each b is independently selected from the group of 6, 8, 10 and 12; each Y is independently an organic group; and each R is independently selected from the group of a hydrogen, an organic group and a halogen, all as discussed herein.

In one embodiment, the hardener compound of the present disclosure has b with a value of 8, each R is a phenyl group (Ph) and Y is a —C₃H₆— group to provide the hardener copolymer represented by formula (W):

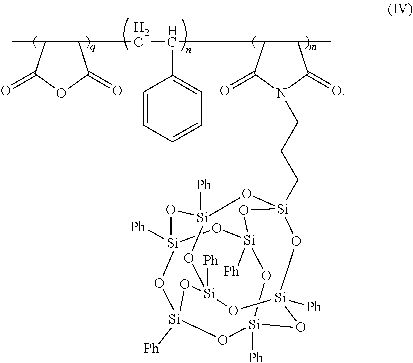

The method of preparing the hardener compound discussed herein can be accomplished in a solution process. The method includes providing the SMA copolymer, as discussed herein, and reacting the SMA copolymer with the amino polyhedral oligomeric silsesquioxane of the formula (VI) (referred to herein as “amino-POSS”) in a solvent to provide the hardener compound of the present disclosure. The amino-POSS can have a primary amino group (—NH₂), as discussed herein.

Commercial examples of the SMA copolymers include, but are not limited to, SMA® 3000, SMA® 4000, SMA®1000, SMA® EF-40, SMA® EF-60 and SMA® EF-80 all of which are available from Sartomer Company, Inc., and SMA® EF-100, which is available from Elf Atochem, Inc. For the various embodiments, the SMA copolymer can have a styrene to maleic anhydride molar ratio of 1:1 to 10:1; for example; the SMA copolymer can have a molar ratio of styrene to maleic anhydride of 3:1 to 6:1.

In an additional example, the SMA copolymer can be formed by reacting monomers of a styrenic compound and a maleic anhydride. The styrenic compound, as used herein, includes the compound styrene having the chemical formula (C₆H₅)—CH═CH₂ and compounds derived therefrom (e.g. styrene derivatives). Maleic anhydride, which may also be referred to as cis-butenedioic anhydride, toxilic anhydride, or dihydro-2,5-dioxofuran, has a chemical formula: C₂H₂(CO)₂O.

The SMA copolymer can have a molecular weight distribution from 1.1 to 4.1; for example, the copolymer can have a molecular weight distribution (e.g., polydispersity index (PDI)) from 1.2 to 2.0. For various embodiments, the SMA copolymer can have an acid number from 100 milligram potassium hydroxide per gram (mg KOH/g) to 480 mg KOH/g; for example, the SMA copolymer can have an acid number from 120 mg KOH/g to 285 mg KOH/g, or from 156 mg KOH/g to 215 mg KOH/g.

Examples of suitable amino-POSS compounds include, but are not limited to, those that contain a primary amino group (—NH₂), such as the amino polyhedral oligomeric silsesquioxane of the formula (VI) provided herein. Examples of such amino-POSS compounds include, but are not limited to, those represented by formula (VIII):

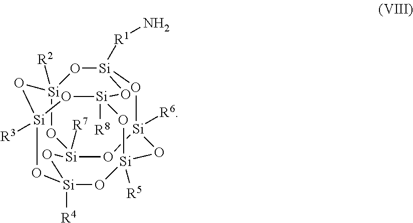

It is appreciated that amino-POSS compounds that contain primary amino group (—NH₂) may also include small amounts of polyfunctional amino-POSS compounds, but it is preferable to keep the amount of amino-POSS compounds having polyfunctional amines to a minimum.

R¹ can be selected from the group of an alkyl group, an aromatic ring or a combination thereof, and each of R², R³, R⁴, R⁵, R⁶, R⁷, and R⁸ is independently selected from the group of a hydrogen, an alkyl group, an olefin and an aromatic ring.

Examples of the alkyl group for R¹ include, but are not limited to, methyl, ethyl, n-butyl, i-butyl, i-octyl, phenyl, and tolyl.

Examples of the aromatic ring for R¹ include, but are not limited to benzene (or phenyl) and methyl substituted benzene (toluene).

Examples of the alkyl group for R², R³, R⁴, R⁵, R⁶, R⁷, and/or R⁸ include, but are not limited to, methyl, ethyl, n-butyl, i-butyl, i-octyl, phenyl, and tolyl.

Examples of the olefin for R², R³, R⁴, R⁵, R⁶, R⁷, and/or R⁸ include, but are not limited to alkenyl groups (e.g., vinyl group) such as ethenyl and propenyl, among others.

Examples of the aromatic ring for R², R³, R⁴, R⁵, R⁶, R⁷, and/or R⁸ include, but are not limited to, benzene, toluene and naphthalene.

Examples of commercially available amino-POSS compounds that contain a primary amino group (—NH₂) include those from Hybrid Plastics® and include, but are not limited to, aminopropyl isobutyl POSS® AM0265; aminopropyl isooctyl POSS® AM0270; aminopropyl phenyl POSS® AM0273; p-aminophenyl cyclohexyl POSS® AM0290; m-aminophenyl cyclohexyl POSS® AM0291; p-aminophenyl isobutyl POSS® AM0292; and m-aminophenyl isobutyl POSS® AM0293

The solvent can be selected from the group of methyl ethyl ketone (MEK), methyl isobutyl ketone (MIBK), toluene, xylene, N,N-dimethyl formamide (DMF), ethyl alcohol, propylene glycol methyl ether (PM), cyclohexanone, propylene glycol methyl ether acetate (DOWANOL™ PMA) or a combination thereof. For various embodiments, the solvent can be used in an amount.

The preparation of the hardener compound of the present disclosure with a determined q, m, and n are prepared using the following general procedure. SMA copolymers with a variety of molecular weights (2000 to 200,000 g/mol) and styrene:maleic anhydride (n:q) ratios ranging from 8:1 to 1:1, as provided herein, are available. The relative molar amount of amino-POSS added and the choice of SMA starting material determines the values of q, m, and n in the hardener compound produced. For example, if an SMA with a number average molecular weight of 2000 g/mol and a styrene:maleic anhydride ratio of 1:1 is chosen (both n and q are about 10), addition of 5 equivalents of amino-POSS give a product hardener with a q, m, and n of 5:10:5 respectively.

For the solution process, the reaction can be carried out in a jacked stir tank reactor. A given amount of the amino-POSS is charged into the reactor with the SMA copolymer and a solvent, where each of the amino-POSS, the SMA copolymer and the solvent are as discussed herein. The SMA-copolymer and the amino-POSS are dissolved in the solvent (e.g., N,N-dimethyl formamide) with heating and stirring to form the reaction mixture and to begin the imidization reaction. Water can be removed from reaction mixture either during the reaction and/or after the reaction to help drive the reaction toward the formation of the imide of the third constitutional unit of the formula (III) seen in the hardener compound.

Suitable approaches to removing water in the reaction mixture include, but are not limited to distillation of a solvent that forms an azeotrope with water, for example benzene, toluene, xylene, MEK, MIBK, cyclohexanone, mixed hydrocarbons, petroleum ether, and alkanes such as hexane, heptane, octane, and decane. When azeotropic removal of water is used, the distilled solvent may be recycled to the reactor after the water is separated. Suitable separation methods are draining of the water or with absorption agents such as silica, molecular sieves, calcium sulfate, calcium chloride, and other solid drying agents.

The process is preferably conducted at atmospheric pressure. When azeotropic removal of water is used, it is possible to influence the composition of the azeotrope and the pot temperature by running at non-atmosperic pressure in the range of 0.5 to 5 bar.

Another approach to removing water from the reaction mixture includes adding an anhydride, such as acetic anhydride, to form acetic acid, thereby driving the reaction toward the imide of the third constitutional unit of the formula (III). For this embodiment, the anhydride is preferably added to the reaction mixture after the amino-POSS has been mixed with the SMA copolymer and the solvent.

The method can also include drying water from the SMA-copolymer and the amino-POSS prior to the reaction. Drying water from the hardener compound can also occur after reacting the SMA copolymer with the amino-POSS.

Reaction temperatures for the solution process can be in a range from 40° C. to 150° C. Exact reaction temperatures can depend upon the choice of solvent used in the reaction mixture. Reaction pressures for the solution process can be at atmospheric pressure. A catalyst can also be used with the reaction mixture, where examples of catalysts include, but are not limited to, those discussed herein. Specific examples of the catalyst include, but are not limited to, inorganic sodium salts (such as sodium carbonate), sodium hydroxide, acetic anhydride, sodium acetate or a combination thereof.

The resulting reaction mixture from the solution process includes the hardener compound of the present disclosure. The reaction mixture can be used directly with an epoxy resin to form the epoxy system of the present disclosure.

The solvent used in the reaction mixture can also be “replaced” with a second solvent different than the one used in the reaction mixture. For example, the solvent (e.g., N,N-dimethyl formamide, toluene or xylene) used in the reaction mixture can first be driven off (e.g., by an evaporation process) and then the second solvent can be used to re-suspend the hardener compound. The hardener compound in the second solvent can then be used with the epoxy resin to form the epoxy system of the present disclosure.

Alternatively, a precipitation process could be used to separate the hardener compound from the solvent used in the reaction mixture. For example, a solvent that is a known “non-solvent” for the hardener compound, but is still miscible with the solvent of the reaction mixture, can be added to the reaction mixture in sufficient quantity to cause the hardener compound to precipitate from the liquid phase. Examples of such a solvent useful with DMF as the reaction mixture solvent can include, but are not limited to, methanol, ethanol, pentane, hexane, and mixed hydrocarbons.

An alternate process for preparing the hardeners is to use a melt process in which the SMA copolymer is heated to allow the copolymer to be combined with the amino-POSS without the need for a solvent. Polymer process equipment must be able to handle high temperatures (>100° C.) and high viscosities (>10 Pa·s). Extruders, kneaders, high viscosity pumps, are suitable. This process has several advantages: the process can be continuous, the throughput is high, and the product is a non-sintering solid. It can be subsequently dissolved in a solvent or added directly to a varnish. Water is a co-product of the reaction between amines and SMA copolymer. It can be removed continuously during the melt process, or subsequently removed in a batch or continuous polymer drier.

The hardener compound, in the form of a precipitant, can then be separated (e.g., filtered) from the liquid phase. Once separated, the hardener compound can then be dried for storage, handling and/or shipping. The hardener compound in the solid form can be re-suspended alone to form a solution of the hardener compound or re-suspended with an epoxy resin to form an embodiment of the epoxy system of the present disclosure. An example of a solvent that can be used to form the solution of the hardener compound or an embodiment of the epoxy system includes a ketone (e.g., methyl ethyl ketone). Examples of other suitable solvents include DMF, xylene, toluene or a combination thereof.

The hardener compound can have a number average molecular weight (Mn) from 1000 to 20000 g/mol, and preferably in the range of 2000 to 8000 g/mol. The number average molecular weight can be determined by gel permeation chromatography (GPC) using tetrahydrofuran as an eluent and calibrated with polystyrene standards or other techniques such as light scattering.

The hardener copolymer of the present disclosure can be a block copolymer, a random copolymer, an alternating copolymer, a periodic copolymer, a statistical copolymer, or a combination thereof.

The hardener compound of the present disclosure can be used with an epoxy resin in an epoxy system. An epoxy resin is a compound in which an oxygen atom is directly attached to two adjacent or non-adjacent carbon atoms of a carbon chain or ring system. The epoxy resin can be selected from the group of aromatic epoxy compounds, alicyclic epoxy compounds, aliphatic epoxy compounds or a combination thereof. The epoxy resin can be selected from the group of aromatic epoxy compounds, alicyclic epoxy compounds, aliphatic epoxy compounds, biphenyl epoxy resins, polyfunctional epoxy resins, naphthalene epoxy resins, divinylbenzene dioxide, 2-glycidylphenylglycidyl ether, dicyclopentadiene-type epoxy resins, phosphorous containing epoxy resin, multi aromatic resin type epoxy resins or a combination thereof.

Examples of aromatic epoxy compounds include, but are not limited to, glycidyl ether compounds of polyphenols, such as hydroquinone, resorcinol, bisphenol A epoxy resins, brominated bisphenol A epoxy resins, bisphenol F epoxy resins, 4,4′-dihydroxybiphenyl, phenol novolac epoxy resins, cresol-novolac epoxy resins, trisphenol (tris-(4-hydroxyphenyl)methane), 1,1,2,2-tetra(4-hydroxyphenyl)ethane, tetrabromobisphenol A, 2,2-bis(4-hydroxyphenyl)-1,1,1,3,3,3-hexafluoropropane, 1,6-dihydroxynaphthalene or a combination thereof.

Examples of alicyclic epoxy compounds (e.g., cycloaliphatic epoxy compounds) include, but are not limited to, polyglycidyl ethers of polyols having at least one alicyclic ring, or compounds including cyclohexene oxide or cyclopentene oxide obtained by epoxidizing compounds including a cyclohexene ring or cyclopentene ring with an oxidizer. Some particular examples include, but are not limited to, hydrogenated bisphenol A diglycidyl ether; 3,4-epoxycyclohexylmethyl-3,4-epoxycyclohexyl carboxylate; 3,4-epoxy-1-methylcyclohexyl-3,4-epoxy-1-methylhexane carboxylate; 6-methyl-3,4-epoxycyclohexylmethyl-6-methyl-3,4-epoxycyclohexane carboxylate; 3,4-epoxy-3-methylcyclohexylmethyl-3,4-epoxy-3-methylcyclohexane carboxylate; 3,4-epoxy-5-methylcyclohexylmethyl-3,4-epoxy-5-methylcyclohexane carboxylate; bis(3,4-epoxycyclohexylmethyl)adipate; methylene-bis(3,4-epoxycyclohexane); 2,2-bis(3,4-epoxycyclohexyl)propane; dicyclopentadiene diepoxide; ethylene-bis(3,4-epoxycyclohexane carboxylate); dioctyl epoxyhexahydrophthalate; di-2-ethylhexyl epoxyhexahydrophthalate; or a combination thereof.

Examples of aliphatic epoxy compounds include, but are not limited to, polyglycidyl ethers of aliphatic polyols or alkylene-oxide adducts thereof, polyglycidyl esters of aliphatic long-chain polybasic acids, homopolymers synthesized by vinyl-polymerizing glycidyl acrylate or glycidyl methacrylate, and copolymers synthesized by vinyl-polymerizing glycidyl acrylate or glycidyl methacrylate and other vinyl monomers. Some particular examples include, but are not limited to glycidyl ethers of polyols, such as 1,4-butanediol diglycidyl ether; 1,6-hexanediol diglycidyl ether; a triglycidyl ether of glycerin; a triglycidyl ether of trimethylol propane; a tetraglycidyl ether of sorbitol; a hexaglycidyl ether of dipentaerythritol; a diglycidyl ether of polyethylene glycol; and a diglycidyl ether of polypropylene glycol; polyglycidyl ethers of polyether polyols obtained by adding one type, or two or more types, of alkylene oxide to aliphatic polyols such as propylene glycol, trimethylol propane, and glycerin; diglycidyl esters of aliphatic long-chain dibasic acids; or a combination thereof.

As discussed herein, the epoxy system of the present disclosure includes the hardener compound and an epoxy resin. In forming the epoxy system, the epoxy resin can be 20 parts by weight to 80 parts by weight based on 100 parts by weight total of the epoxy system. For example the epoxy resin can be from 25 parts by weight to 75 parts by weight, or 30 parts by weight to 70 parts by weight based on 100 parts by weight total of the epoxy system. For the epoxy system, the hardener compound can be 20 parts by weight to 80 parts by weight based on 100 parts by weight total of the epoxy system. For example the hardener compound can be from 25 parts by weight to 75 parts by weight, or 30 parts by weight to 70 parts by weight based on 100 parts by weight total of the epoxy system.

The stoichiometry between the epoxy resin and the hardener compound can be selected to achieve desirable properties. Only the anhydride portion of the hardener compound reacts with the epoxy group of the epoxy resin. Each molecule of the hardener compound can therefore have multiple reaction sites corresponding to the number of anhydride groups in the chain (designated by q). Preferred molar ratios of epoxy to anhydride groups are in the range of 0.8:1:0 to 2.7:1.0, more preferably 0.9:1.7 to 1.7:1.0 and most preferably from 1.0:1.0 to 1.5:1.0. Generally speaking, as the molar ratio (epoxy:anhydride) increases, both the Tg and the Df increase. For the best dielectric properties (low Df), it is desirable to formulate with high epoxy:anhydride ratios. For the highest Tg high epoxy:anhydride ratios work best.

When the hardener compound and epoxy resin are used in a varnish formulation, solvents can be used to modify (e.g., reduce) the viscosity, to modify (e.g. improve) the solubility of the hardener compound(s) and/or epoxy resin(s), and/or to modify (e.g., improve) the appearance of a prepreg made with the hardener compound(s) and epoxy resin(s). Suitable solvents can include, but are not limited to, acetone, methyl ethyl ketone (MEK), toluene, xylene, N,N-dimethyl formamide (DMF), ethyl alcohol, propylene glycol methyl ether (PM), cyclohexanone, propylene glycol methyl ether acetate (DOWANOL™ PMA) or a combination thereof. The preferred solvent concentration is in the range of 10 to 60 wt %, with 30 to 50 wt % preferred, where the wt % is based on the total weight of the epoxy system (e.g., varnish formulation).

The epoxy system can include a catalyst, where the catalyst is used in curing the epoxy system. Examples of the catalyst include, but are not limited to, 2-methyl imidazole (2MI), 2-phenyl imidazole (2PI), 2-ethyl-4-methyl imidazole (2E4MI), 1-benzyl-2-phenylimidazole (1B2PZ), boric acid, triphenylphosphine (TPP), tetraphenylphosphonium-tetraphenylborate (TPP-k) or a combination thereof. For the various embodiments, the catalyst (e.g., a 10% solution by weight) can be used in an amount of from 0.01% to 2.0% by weight based on solid component weight in the epoxy system.

The epoxy system can also include a co-curing agent. The co-curing agents can be reactive to the epoxide groups of the epoxy resin. The co-curing agent can be selected from the group of novolacs, amines, anhydrides, carboxylic acids, phenols, thiols, or a combination thereof. For the various embodiments, the co-curing agent can be used in an amount of from 1% to 90% by weight based on a weight of the hardener compound.

The epoxy system can also include at least one of an additive. The additive can be selected from the group consisting of dyes, pigments, colorants, antioxidants, heat stabilizers, light stabilizers, plasticizers, lubricants, flow modifiers drip retardants, flame retardants, antiblocking agents, mold release agents, toughening agents, low-profile additives, stress-relief additives, or a combination thereof. The additive can be employed in an effective amount for a particular application, as is understood by one having ordinary skill in the art. For different applications, the effective amount can have different values.

Embodiments of the present disclosure provide a prepreg that includes the hardener compound of the present disclosure. For example, the prepreg can include the epoxy resin and the hardener compound (e.g., the epoxy system of the present disclosure) in addition to a reinforcement component. The prepreg can be obtained by a process that includes impregnating the epoxy system into the reinforcement component. Impregnating the epoxy system into the reinforcement component may be accomplished by a variety of processes, such as rolling, dipping, spraying, or other such procedures. After the prepreg reinforcement component has been contacted with the epoxy system, any solvent can be removed via volatilization and the epoxy system can be partially cured. This volatilization of the solvent and/or the partial curing can be referred to as B-staging. The B-staged product can be referred to as the prepreg.

For some applications, forming the prepreg can occur via an exposure to a temperature of 60° C. to 250° C.; for example forming the prepreg can occur via an exposure to a temperature from 65° C. to 240° C., or 70° C. to 230° C. For some applications, forming the prepreg can occur for a period of time of 1 minute to 60 minutes; for example forming the prepreg can occur for a period of time from, 2 minutes to 50 minutes, or 5 minutes to 40 minutes. However, for some applications forming the prepreg can occur at another temperature and/or another period of time.

The reinforcement component can include fibers, fabrics and/or mats. Examples of materials for these reinforcement components include, but are not limited to, glass, aramid, carbon, polyester, polyethylene, quartz, metal, ceramic, biomass, or a combination thereof. The materials can be coated, where an example of such a coating is boron. Specific examples of the reinforcement component can be a glass fabric or other polymeric fabrics or commingled glass fiber and polymeric fibers. Examples of glass fabrics include those under the designation 7628, 1080, as well as advanced glasses like NOVASPEED 1080™.

Examples of glass fibers include, but are not limited to, A-glass fibers, E-glass fibers, C-glass fibers, R-glass fibers, S-glass fibers, T-glass fibers, or a combination thereof. Aramids are organic polymers, examples of which include, but are not limited to, Kevlar®, Twaron®, or a combination thereof. Examples of carbon fibers include, but are not limited to, those fibers formed from polyacrylonitrile, pitch, rayon, cellulose, or a combination thereof. Examples of metal fibers include, but are not limited to, stainless steel, chromium, nickel, platinum, titanium, copper, aluminum, beryllium, tungsten, or a combination thereof. Examples of ceramic fibers include, but are not limited to, those fibers formed from aluminum oxide, silicon dioxide, zirconium dioxide, silicon nitride, silicon carbide, boron carbide, boron nitride, silicon boride, or a combination thereof. Examples of biomass fibers include, but are not limited to, those fibers formed from wood, non-wood, or a combination thereof.

The reinforcement component can be a fabric. The fabric can be formed from the fiber, as discussed herein. Examples of fabrics include, but are not limited to, stitched fabrics, woven fabrics, or a combination thereof. The fabric can be unidirectional, multiaxial, or a combination thereof. The reinforcement component can be a combination of the fiber and the fabric.

One or more of the prepregs may be cured (e.g. more fully cured) to obtain a cured product. The prepregs can be layered and/or formed into a shape before being cured further. For some applications (e.g. when an electrical laminate structure is being produced) layers of the prepreg can be alternated with layers of a conductive material. An example of the conductive material includes, but is not limited to, copper foil. The prepreg layers can then be exposed to conditions so that the matrix component becomes more fully cured.

Because of their unique combination of properties, the hardener compound and the epoxy system of the present disclosure may be used in a variety of ways. For example, the hardener compound can be used in forming a varnish, in a prepreg and/or in an electrical laminate structure. For example, the reaction product of the epoxy system can be used in forming an electrical laminate structure. The hardener compound and the epoxy system of the present disclosure may also be used in shaped articles, reinforced compositions, laminates, coating, molded articles, adhesives, and/or composite products. In addition, the hardener compound and the epoxy system of the present disclosure may be used for various purposes in the form of a dried powder, pellets, a homogeneous mass, impregnated products and/or other compounds.

### EXAMPLES

The following examples are given to illustrate, but not limit, the scope of this disclosure. The examples provide methods and specific embodiments of the hardener compound and the epoxy system that includes the hardener compound of the present disclosure.

### Materials

SMA® EF-40 (SMA 40) styrenic compound-maleic anhydride copolymer, available from Sartomer Company, Inc. SMA 40 has a styrene to maleic anhydride molar ratio of 4:1, a weight average molecular weight (Mw) of 10500 g/mol, a number average molecular weight (Mn) of 4500 g/mol, a molecular weight distribution of 2.3, and an acid number of 215 mg KOH/g.

SMA® EF-60, (SMA 60) styrenic compound-maleic anhydride copolymer, available from Sartomer Company, Inc. SMA 60 has a styrene to maleic anhydride molar ratio of 6:1, a weight average molecular weight (Mw) of 11500 g/mol, a number average molecular weight (Mn) of 5500 g/mol, a molecular weight distribution of 2.1, and an acid number of 156 mg KOH/g.

N, N-dimethyl formamide (DMF) available from Sigma Aldrich.

Aminopropylphenyl-polyhedral oligomeric silsesquioxanes (amino-POSS, available from Hybrid Plastics® part number AM-0273).

Aminopropyl(i-butyl)-polyhedral oligomeric silsesquioxanes (amino-i-butyl-POSS, available from Hybrid Plastics® part number AM-0265)

Aminopropylisooctyl-polyhedral oligomeric silsesquioxanes (amino-POSS, available from Hybrid Plastics® part number AM-0270).

Acetic anhydride (Ac₂O, analytical grade) available from Sigma Aldrich.

Sodium acetate (NaOAc, analytical grade) available from Sigma Aldrich.

Methanol (analytical grade), available from Sinopharm Chemical Co.

Boric acid, available from Sigma Aldrich.

Tetrahydrofuran HPLC grade), available from Sigma Aldrich.

D.E.R.™ 560 (brominated oligomeric epoxy resin with a bromine content of 48% by weight and an epoxy equivalent weight of 455 g/equivalent), available from The Dow Chemical Company.

Methyl ethyl ketone (MEK, reagent grade), available from Sigma Aldrich.

2-Methyl imidazole (2-MI), available from Sigma Aldrich.

Xylene, available from Sigma Aldrich.

Sodium carbonate, available from Sigma Aldrich.

Sodium hydroxide (NaOH), available from Sigma Aldrich.

### Hardener Compound Example (HC Ex) 1

Prepare HC Ex 1 as follows. Add 15 grams (g) of SMA 40 to a 250 milliliter (ml) flask, equipped with a refluxing condenser, thermometer, and nitrogen (N₂) inlet. Add 100 ml of DMF to the flask and charge the flask with N₂ for five minutes to remove air from the flask. To keep a constant N₂ pressure in the flask, seal the N₂ outlet with silicone oil through a U-tube. Heat the contents of the flask to 50° C. to completely dissolve the SMA 40 in the DMF.

Mix 1.5 g of the amino-POSS (AM-0273) in 25 ml of DMF to form an amino-POSS solution. Add the amino-POSS mixture to the solution of SMA 40 and DMF at 50° C. After 2 hours (hrs) increase the temperature of the amino-POSS mixture and the solution of SMA 40 and DMF from 50° C. to 140° C. When the reaction temperature reaches 100° C., add 4.84 g of acetic anhydride and 1.0 g of sodium acetate into the amino-POSS mixture and the solution of SMA 40 and DMF. Allow the reaction to proceed for 5 hrs, after which remove the heat to the flask and allow the contents of the flask to cool to room temperature (23° C.).

Filter the contents of the flask through a paper filter to remove residual powder of the Amino-POSS and superfluous sodium acetate. Drip the filtered content of the flask into excess methanol (room temperature) with magnetic stirring (a 1 to 10 volume ratio of the filtered content of the flask to the methanol) to form a precipitate. Separate the precipitate using a paper. Allow the precipitate to remain in a fume hood for at least 3 hrs to allow residual methanol to dissipate. Dry the precipitate in a vacuum oven (set at 0.1 MPa and 120° C.) for 12 hrs. The resulting product is HC Ex 1 of the present disclosure.

### HC Ex 2

In forming HC Ex 2 of the hardener compound of the present disclosure repeat the method of HC Ex 1 with the following changes. Mix 12 g of amino-POSS (AM-0273) in 25 ml of DMF to form an amino-POSS solution. The resulting product is HC Ex 2 of the present disclosure.

### HC Ex 3

In forming HC Ex 3 of the hardener compound of the present disclosure repeat the method of HC Ex 1 with the following changes. Use SMA 60 in place of SMA 40. Mix 1.05 g of the amino-POSS (AM-0273) in 25 ml of DMF to form an amino-POSS solution. The resulting product is HC Ex 3 of the present disclosure.

### HC Ex 4

In forming HC Ex 4 of the hardener compound of the present disclosure repeat the method of HC Ex 1 with the following changes. Use SMA 60 in place of SMA 40. Mix 3.15 g of the amino-POSS (AM-0273) in 25 ml of DMF to form the amino-POSS solution. The resulting product is HC Ex 4 of the present disclosure.

### HC Ex 5 Through HC Ex 8

Prepare HC Ex 5 through HC Ex 8 as follows. Add SMA 40 to a 500 ml flask, equipped with a refluxing condenser, a Dean-Stark trap, thermometer, and nitrogen (N₂) inlet according to the amounts shown in Table 1. Add xylene to the flask, according to the amounts shown in Table 1, and charge the flask with N₂ for five minutes to remove air from the flask. To keep a constant N₂ pressure in the flask, seal the N₂ outlet with silicone oil through a U-tube. Heat the contents of the flask to 50° C. to completely dissolve the SMA 40 in the xylene.

Add amino-i-butyl-POSS (AM-0265) to the contents of the flask, according to the amounts shown in Table 1, and stir at 50° C. for 2 hrs. After the 2 hrs add sodium carbonate to the contents of the flask, according to the amounts shown in Table 1, and increase the temperature from 50° C. to 145° C. to maintain a vigorous reflux inside the reaction system. Remove water from the burette of the Dean-Stark trap. Allow the reflux to continue for 5 hrs. After 5 hrs stop the heating and stirring and allow the contents of the flask to cool to room temperature.

Use HC Ex 5 through HC Ex 8 as produced (e.g., in xylene without further purification).

TABLE 1
Synthesis of HC Ex 5 through HC Ex 8 in Xylene

| | HC Ex 5 | HC Ex 6 | HC Ex 7 | HC Ex 8 |
|---|---|---|---|---|
| Target Mol. % of Third | 15 | 20 | 25 | 30 |
| Constitutional Unit | | | | |
| (formula (III)) | | | | |
| SMA 40 (g) | 100 | 100 | 100 | 100 |
| Amino-i-butyl POSS (g) | 25.5 | 34 | 42.5 | 51 |
| Xylene (g) | 222 | 237 | 252 | 267 |
| Sodium carbonate (g) | 0.167 | 0.412 | 0.189 | 0.618 |
| Maleic anhydride (MAH) | 12.39 | 10.68 | 10.43 | 8.00 |
| content (wt %, | | | | |
| FTIR Analysis) | | | | |

### HC Ex 9 and HC Ex 10

Prepare HC Ex 9 and HC Ex 10 as follows. Add SMA 40 to a 500 ml flask, equipped with a refluxing condenser, a Dean-Stark trap, thermometer, and nitrogen (N₂) inlet according to the amounts shown in Table 2. Add either xylene or methyl ethyl ketone (MEK) (solvent) to the flask, according to the amounts shown in Table 2, and charge the flask with N₂ for five minutes to remove air from the flask. To keep a constant N₂ pressure in the flask, seal the N₂ outlet with silicone oil through a U-tube. Heat the contents of the flask to 50° C. to completely dissolve the SMA 40 in the solvent.

Add amino-i-butyl-POSS to the contents of the flask, according to the amounts shown in Table 2, and stir at 50° C. for 2 hrs. After the 2 hrs add a catalyst, according to the type and amounts shown in Table 2, to the contents of the flask, and increase the temperature from 50° C. to the temperature indicated in Table 2. As needed, remove water from the burette of the Dean-Stark trap. Allow the reaction to continue for 5 hrs. After 5 hrs stop the heating and stirring and allow the contents of the flask to cool to room temperature.

Use HC Ex 9 and HC Ex 10 as produced (e.g., in solvent without further purification).

TABLE 2
Synthesis of HC Ex 9 and HC Ex 10

| | HC Ex 9 | HC Ex 10 |
|---|---|---|
| Target Mol. % of Third | 30 | 30 |
| Constitutional Unit (formula (III)) | | |
| SMA 40 (g) | 44 | 100 |
| Amino-i-butyl POSS (g) | 22.95 | 51 |
| Solvent (g) | MEK, | Xylene, |
| | 120 | 252 |
| Ring-closure reagents (g) | Ac₂O, 3; | NaOH |
| | NaOAc, 6 | 0.093 |
| Ring-closure reaction conditions | 5 hr at 80° C. | 5 hr at |
| | | reflux |
| | | (145° C. |
| | | Water |
| | | separation |
| Maleic Anhydride (MAH) | 8.73 | 8.23 |
| Content (wt %, FTIR Analysis) | | |

### Silicon Content of the POSS Content of HC Ex 1 Through HC Ex 4

Determine the silicon content of the POSS content of HC Ex 1 through HC Ex 4 using Thermogravimetric Analysis (TGA) with the following procedure:

Weigh a sample of the amino-POSS (AM-0273) (6.0 to 10.0 mg) in a platinum pan. Place the pan in a TA Instruments Thermal Analysis (Q5000 machine), and ramp the temperature up to 900° C. (heating rate 20° C./min). Use a 60 milliliter per minutes (ml/min) flow of air. Calculate the Si content from the SiO₂ residue in the pan. The Si content in the amino-POSS (AM-0273) is 17.4% by weight.

Once the Si content of the amino-POSS was determined, a series of samples with varying amounts of amino-POSS was prepared to generate a calibration curve for analysis by X-ray diffraction (XRF). The procedure was as follows:

A mixture with varying ratios of SMA (both SMA 40 and SMA 60), amino-POSS (AM-0273), and boric acid (see Table A below) was mixed at 700 rpm for 5 minutes in a pulverisette 7″ Planetary Micro Mill. The resulting powders were pressed into pellets with a SPEX X-Press 3630 at a pressure of 25 tons, a hold time of 3 minutes, and a release time of 1 minute. The prepared wafer diameter is about 40 mm and the thickness is about 3.0 mm. The wafer was removed from the press and the Si content was measure by XRF. A calibration curve of Si content in the 6 samples versus the Si peak size by XRF was generated.

TABLE A
The formulation and calculated Si content in mixed powders
Standard sample preparation for SMA-POSS
sample analysis-Si % determination

| | SMA (AM- | Amino-POSS | | |
|---|---|---|---|---|
| Name | 0273) (g) | (g) | Boric acid (g) | Si % * |
| std 0 | 0.0000 | 0.0000 | 6.0049 | 0.00% |
| std 1 | 3.7576 | 1.4648 | 1.1649 | 3.99% |
| std 2 | 2.7074 | 2.4404 | 0.9368 | 6.98% |
| std 3 | 1.5027 | 3.5276 | 1.0190 | 10.15% |
| std 4 | 0.9560 | 3.9394 | 0.9894 | 11.65% |
| std 5 | 0.7274 | 4.2927 | 1.0336 | 12.34% |

The Si content of samples of amino-POSS blocked SMA were milled and pressed into a wafer to test the Si peak strength with XRF. The standard curve was then used to calculate the Si content.

### Quantitative FTIR Analysis

Determine the content of maleic anhydride (MAH) units in HC Ex 1 through HC Ex 12 by quantitative FTIR analysis. The procedure is as follows. Dissolve free maleic anhydride (MAH) into THF (dried over molecular sieves) at different concentrations to prepare calibration curves.

Place powder samples of HC Ex 1 through HC Ex 12 (3.00 g+/−0.01 g) into a vacuum oven for 2 hours at 100° C. Remove the samples from the vacuum oven and cool them in a desiccator. Dissolve each of the cooled samples in 10 ml of THF.

Use the FTIR (Nicolet 6700) with liquid for calibration curve setup and unknown MAH concentration test. Assign the 1780 cm⁻¹ peak in the FTIR spectra to symmetrical vibration of carbonyl of MAH. According to the Lambert-Beer law, the peak height is proportional to MAH concentration. Use the relationship to establish the calibration curve. Use the calibration curve to determine MAH concentration of HC Ex 1 through HC Ex 12.

The determined MAH content for HC Ex 1 through HC Ex 4 are shown in Table 3. Determined MAH content for HC Ex 5 through HC Ex 10 are shown in Tables 1 and 2, above.

TABLE 3
POSS content, Tg and MAH content of HC Ex 1 through HC Ex 4

| | | | | MAH |
|---|---|---|---|---|
| | | | | content |
| | POSS Content (wt. %) | | Tg | FTIR |
| | TGA (wt. %) | XRF (wt. %) | DSC (° C.) | (wt . %) |
| SMA 40 (control) | xx | xx | 112 | 19.1 |
| HC Ex 1 | 2.5 | 2 | 131 | 12 |
| HC Ex 2 | 26.8 | 27.1 | 146 | 7 |
| SMA 60 (control) | xx | xx | 101 | 13.58 |
| HC Ex 3 | 0.89 | 1.34 | 120 | 10 |
| HC Ex 4 | 11.34 | 13.43 | 123 | 9 |

### Epoxy System (ES)

Using the amounts shown in Table 4, prepare an Epoxy System (ES) using each of the Hardener Compounds of HC Ex 1 through HC Ex 4 (Epoxy System Example (ES Ex) 1 through ES Ex 4) and Comparative Examples A and B (Com Ex A and Com Ex B) as follows.

Dissolve HC Ex 1 through HC Ex 4 in MEK according to Table 4. Add D.E.R.™ 560 to the solution according to Table 4. Dissolve 2-methyl imidazole (2-MI, 1.00 g+/−0.01 g) in methanol (9.00 g+/−0.01 g) to) to form a 10 wt % solution. The final weight percent of non-volatile organics is 50% by weight.

For Com Ex A and B, dissolve SMA 40 and SMA 60 in MEK according to Table 4. Add D.E.R.™ 560 to the solution according to Table 4.

TABLE 4
Epoxy System (ES) Examples 1 through 4

| Com Ex A | | Com Ex B | |
|---|---|---|---|
| | Weight | | Weight |
| | (g) | | (g) |
| D.E.R. ™ 560 | 10 | D.E.R ™ 560 | 10 |
| SMA 40 | 10.3 | SMA 60 | 14.4 |
| 2-MI (10% in methanol) | 0.10 | 2-MI (10% in methanol) | 0.19 |
| MEK | 13.5 | MEK | 24.4 |
| EEW/HEW | 1.1:1 | EEW/HEW | 1.1:1 |
| processing | Casting | processing | Casting |
| ES Ex 1 | | ES Ex 2 | |
| | Weight | | Weight |
| | (g) | | (g) |
| D.E.R. ™ 560 | 10 | D.E.R. ™ 560 | 10 |
| HC Ex 1 | 16.3 | HC Ex 2 | 28 |
| 2-MI (10% in methanol) | 0.29 | 2-MI (10% in methanol) | 0.57 |
| MEK | 26.3 | MEK | 38 |
| EEW/HEW | 1.1:1 | EEW/HEW | 1.1:1 |
| processing | Casting | processing | Casting |
| ES Ex 3 | | ES Ex 4 | |
| | Weight | | Weight |
| | (g) | | (g) |
| D.E.R. ™ 560 | 10 | D.E.R. ™ 560 | 10 |
| HC Ex 3 | 19.6 | HC Ex 4 | 21.8 |
| 2-MI (10% in methanol) | 0.44 | 2-MI (10% in methanol) | 0.50 |
| MEK | 29.6 | MEK | 31.8 |
| EEW/HEW | 1.1:1 | EEW/HEW | 1.1:1 |
| Processing | Casting | Processing | Casting |

In Table 5 ‘EEW/HEW’ is the ratio of the epoxy equivalent weight (EEW) to the hardener equivalent weight (HEW). The EEW was taken from the technical data sheet for the epoxy resin (455 g/eq). The HEW of the amino-POSS blocked SMA was calculated from the anhydride content that was determined using infrared spectroscopy. For example, for HC Ex 3, the measure maleic anhydride content was 10 wt %. The HEW is therefore 1/(10%/98.06 g/mol))=981 g/eq, given that 1 mol of anhydride is equal to 1 equivalent of hardener.

Using the amount shown in Table 5, prepare ES Ex 5 through ES Ex 8 using each of the Hardener Compounds of HC Ex 5 through HC Ex 8 as follows. Add D.E.R.™ 560 to HC Ex 5 through HC Ex 8, each in xylene, according to Table 5. A solution of 2-MI in methanol 10 wt % was used to make it easier to accurately add the small amount required (0.60 g solution containing 0.06 g 2-MI). The final weight percent of non-volatile organics is 50% by weight.

TABLE 5
Epoxy System with Varying Ratios of Epoxy Resin/Hardener Compound

| Epoxy System | ES Ex 5 | | | ES Ex 6 | | |
|---|---|---|---|---|---|---|
| Target Mol. % of Third | 15 | | | 20 | | |
| Constitutional Unit (formula (III)) | | | | | | |
| Maleic Anhydride (MAH) Content | 12.39 | | | 10.68 | | |
| (wt %, FTIR Analysis) | | | | | | |
| Epoxy Resin/Hardener Compound | 0.9 | 1.1 | 1.3 | 0.9 | 1.1 | 1.3 |
| (Molar ratio) | | | | | | |
| Hardener Compound (g) | HC Ex 5 | | | HC Ex 6 | | |
| | 13.18 | 12.25 | 11.45 | 13.83 | 12.94 | 12.16 |
| D.E.R. ™ 560 (g) | 6.82 | 7.75 | 8.55 | 6.17 | 7.06 | 7.84 |
| 2-MI (g) | 0.06 | 0.06 | 0.06 | 0.06 | 0.06 | 0.06 |
| Xylene (g) | 23.17 | 21.54 | 20.13 | 21.16 | 19.79 | 18.60 |
| Cure temperature (° C.) and time | 200x1 | 200x1 | 200x1 | 200x1 | 200x1 | 200x1 |
| (hr) | then | then | then | then | then | then |
| | 220x3 | 220x3 | 220x3 | 220x3 | 220x3 | 220x3 |
| Gel time (s) | 320 | 330 | 310 | 275 | 225 | 213 |
| Tg (° C., DSC) | 174 | 187 | 189 | 164 | 173 | 183 |
| Dk (1 GHz) | 2.90 | 2.88 | 2.89 | 2.82 | 2.82 | 2.86 |
| Df (1 GHz) | 0.0041 | 0.0052 | 0.0059 | 0.0029 | 0.0045 | 0.0055 |
| Epoxy System | ES Ex 7 | | | ES Ex 8 | | |
| Target Mol. % of Third | 25 | | | 30 | | |
| Constitutional Unit (formula (III)) | | | | | | |
| Maleic Anhydride (MAH) Content | 10.43 | | | 8.00 | | |
| (wt %, FTIR Analysis) | | | | | | |
| Epoxy Resin/Hardener Compound | 0.9 | 1.1 | 1.3 | 0.9 | 1.1 | 1.3 |
| (Molar ratio) | | | | | | |
| Hardener Compound (g) | HC Ex 7 | | | HC Ex 8 | | |
| | 13.93 | 13.05 | 12.28 | 14.99 | 14.20 | 13.49 |
| D.E.R. ™ 560 (g) | 6.07 | 6.95 | 7.72 | 5.01 | 5.80 | 6.51 |
| 2-MI (g) | 0.06 | 0.06 | 0.06 | 0.06 | 0.06 | 0.06 |
| Xylene (g) | 22.39 | 20.98 | 19.74 | 27.32 | 25.88 | 24.59 |
| Cure temperature (° C.) and time | 200x1 | 200x1 | 200x1 | 200x1 | 200x1 | 200x1 |
| (hr) | then | then | then | then | then | then |
| | 220x3 | 220x3 | 220x3 | 220x3 | 220x3 | 220x3 |
| Gel time (s) | 305 | 300 | 295 | 275 | 225 | 215 |
| Tg (° C., DSC) | 164 | 168 | 173 | 158 | 157 | 165 |
| Dk (1 GHz) | 2.90 | 2.81 | 2.86 | 2.88 | 2.8 | 2.83 |
| Df (1 GHz) | 0.0033 | 0.0041 | 0.0059 | 0.002 | 0.0035 | 0.0047 |

Table 5 shows that the cured epoxy resins formed with the hardener compounds HC Ex 5 through HC Ex 8 (formed with the amino-i-butyl POSS) show low Df in the range of 0.002-0.006. At fixed MAH content (wt. %), Df and Tg values both increases as the molar ratio of epoxy resin/hardener compound increases from 0.9 to 1.3. The best Df values are observed when the molar ratio of epoxy resin/hardener compound is 0.9.

TABLE 6
Epoxy System with Hardener Compound formed with
Ac₂O/NaOAc, NaOH or Na₂CO₃.

| Epoxy System | ES Ex 9 | ES Ex 10 | ES Ex 8 |
|---|---|---|---|
| Target Mol. % of Third | 30 | | |
| Constitutional Unit | | | |
| (formula (III)) | | | |
| Maleic Anhydride | 8.73 | 8.23 | 8.00 |
| (MAH) Content (wt %, | | | |
| FTIR Analysis) | | | |
| Epoxy Resin/Hardener | 1.1:1 | | |
| Compound (Molar ratio) | | | |
| Hardener Compound (g) | HC Ex 9, 19.13 | HC Ex 10, 7.04 | HC Ex 8, 14.20 |
| D.E.R. ™ 560 (g) | 8.58 | 2.96 | 5.80 |
| 2-MI (g) | 0.083 | 0.03 | 0.06 |
| Cure temperature (° C.) | 200 × 1 then | 200 × 1 then | 200 × 1 then |
| and time (hr) | 220 × 3 | 220 × 3 | 220 × 3 |
| Gel time (s) | 258 | 312 | 225 |
| Tg (° C., DSC) | 173 | 165 | 157 |
| Dk (1 GHz) | 2.85 | 2.81 | 2.8 |
| Df (1 GHz) | 0.003 | 0.0026 | 0.0035 |

As shown in Table 6, the cured epoxy systems formed with the hardener compounds HC Ex 8 through HC Ex 10 (formed with different catalysts) showed similar dielectric properties, while the processes using NaOH or Na₂CO₃ as ring-closure reagent are simpler than the process using NaOAc/Ac₂O.

### Gelation Time Test

Evaluate the Epoxy Systems of Tables 4-6 for gelation time via a stroke cure on a 171° C. hot plate using the procedure described in US20120264870A. The gel time is show in Table 7 and in Tables 5 and 6.

TABLE 7
Gel time of Epoxy Systems of Table 2

| | Catalyst content (wt. %) | |
|---|---|---|
| | based on solid content | Gel time (s) |
| ES Ex 1 | 1.1 | 259 |
| ES Ex 2 | 1.5 | 267 |
| ES Ex 3 | 1.5 | 262 |
| ES Ex 4 | 1.6 | 276 |
| Com Ex A | 0.5 | 242 |
| Com Ex B | 0.77 | 247 |

### Thermal Gravimetric Analysis (TGA)

Thermal gravimetric analysis of films formed from the Epoxy Systems of Tables 4-6 was measured as follows. Add a 10 g sample of the varnish to a beaker. Place the beaker in a vacuum oven at 80° C. for one hour to remove the solvent from the sample. Grind the resultant solid into a powder. Further dry the powder and pre-cured in a vacuum oven for one hour at 80° C. The resulting product is a pre-cured powder. Press this powder for 4 hours at 200° C. to give a film that was tested using a TGA (TA Instrument Q5000). Ramp the sample (˜6 mg) from 20° C. to 700° C. at 20° C./min. Use a nitrogen flow of 25 ml/min.

### Glass Transition Temperature

Determine the glass transition temperature (T_{g}) of samples of the Epoxy Systems of Tables 4-6 and 11, cured as described herein, as follows. Use a RSA III dynamic mechanical thermal analyzer (DMTA) to determine the Tg's of the cured samples of the Epoxy Systems of Tables 4-6 and 11. Heat samples from room temperature to 250° C. at 3° C./min heating rate at a test frequency of 6.28 rad/s. Obtain the T_{g} of the cured epoxy resin from the maximum of the tangent delta peak. Tg values for the cured samples of the Epoxy Systems of Tables 4-6 and 11 are provided in Tables 5, 6, 8, 9 and 12.

### Degradation Temperature (Td)

Thermal stability analysis was used to determine degradation temperatures (Td) for the cured samples of the Epoxy Systems of Table 4. The thermal stability analysis employed a Q5000 machine (TA Instruments) that utilized a heating rate of 20.0° C./min. Td was determined as the temperature at 5% weight loss of the Epoxy Systems of Table 4 occurred. Td values for the cured samples of the Epoxy Systems of Table 4 are shown in Tables 8 and 9.

### Number Average Molecular Weight (Mn)

The number average molecular weight was determined by gel permeation chromatography (GPC) using tetrahydrofuran as an eluent and calibrated with polystyrene standards.

### Dielectric Constant (Dk)/Dissipation Factor (Df) Measurements

Crush the cured samples of the Epoxy Systems of Tables 4-6 and 11 to a powder. Place the powder flat aluminum foil and place the aluminum foil with the powder on a flat metal plate and then heat to 200° C. until the powder melts. Cover the melted powder with another piece of aluminum foil, place a flat metal plate on the aluminum foil and then press at 200° C. for 1 hr and then at 220° C. for 3 hrs. A void-free epoxy plaque with a thickness of 0.4 millimeters (mm) to 0.8 mm was obtained.

Dielectric Constant (Dk):

The dielectric constant of 0.4 millimeter (mm) thick samples of cured products of the Epoxy Systems of Tables 4-6 and 11 was determined by ASTM D-150 employing an Agilent E4991A RF impedance/material analyzer, the results of which are in Tables 5, 6, 8, 9 and 12.

Dissipation Factor (Df):

The dissipation factor of respective 0.4 mm thick samples of cured products of the Epoxy Systems of Tables 4-6 and 11 was determined by ASTM D-150 employing the Agilent E4991A RF impedance/material analyzer under 1 GHz at 24° C., the results of which are in Tables 5, 6, 8, 9 and 12.

TABLE 8
The properties of Epoxy System based on SMA 40

| | POSS content | | | | | |
|---|---|---|---|---|---|---|
| | (wt. %) | | Tg | Td | Dk | |
| | TGA | XRF | (° C.) | (° C.) | @ 1 | Df @ |
| Systems | (wt. %) | (wt. %) | (DMA) | (TGA) | GHz | 1 GHz |
| Com Ex A [symbol] | xx | xx | 162 | 354 | 3.02 | 0.011 |
| ES Ex 1 [symbol] | 1.5 | ~1.2 | 196 | xx | 2.95 | 0.005 |
| ES Ex 2 [symbol] | ~18 | ~18.2 | 184 | 373 | 3.02 | 0.003~0.004 |
| ES Ex 2 [symbol] | ~18 | ~18.2 | 195 | 380 | 2.94 | 0.002 |

[symbol]

Cured at 200° C. for 4 hours; [symbol]
Cured at 200 ° C. for 1 hour

TABLE 9
The properties of Epoxy System based on SMA 60

| | POSS content | | | | | |
|---|---|---|---|---|---|---|
| | (wt. %) | | | | | |
| | TGA | XRF | Tg (° C.) | Td (° C.) | Dk @ | Df @ |
| Systems | (wt. %) | (wt. %) | (DMA) | (TGA) | 1 GHz | 1 GHz |
| Com Ex B | xx | xx | 152 | 343 | 2.91 | 0.006 |
| ES Ex 3 | ~0.6 | ~0.9 | 180 | 366 | 2.89 | 0.005 |
| ES Ex 4 | ~7.6 | ~9 | 182 | 370 | 2.89 | 0.004 |

### HC Ex 11 and HC Ex 12

The weights of the reagents for HC Ex 11 and HC Ex 12 are shown in Table 10, below. Add xylenes to a 2 L 4-necked round bottom flask equipped with a Dean-Stark trap, condenser, thermocouple, nitrogen inlet, and an overhead stirrer. Add SMA 40 to the flask and heat contents to 70° C. Dissolve the SMA 40 and then cool the contents of the flask to 50° C. Add the SMA-POSS to the flask over 30 minutes. Add NaOH (50 wt % in water) to the flaks and heat the contents to reflux (145° C.) and stir for 6 hours. Collect the xylene and water in the Dean Stark trap. After 6 hours, allow the reaction to cool and transfer the content of the flask to a storage container. Determine the solids content of the production solution by weighing a 1.0 g sample into an aluminum weigh boat. Place the sample in a vacuum oven at 80° C. to remove the solvent. After evaporation of the solvent, re-weigh the pan to determine solids content.

TABLE 10

| | HC Ex 11 | HC Ex 12 |
|---|---|---|
| SMA EF-40, (g) | 345 | 536 |
| POSS AM-0270, (g) | — | 400 |
| POSS AM-0265, (g) | 675 | — |
| xylene, (g) | 900 | 900 |
| NaOH (50 wt % in | 0.15 | 0.09 |
| water), (g) | | |

HC Ex 11 has a number average molecular weight (Mn) of 4500, with q=6, n=35, m is approximately 3. The value n/(q+m)=3.9 and q/m=2. The weight percent (wt. %) of the first constitutional unit (formula (I)) is 9%, the wt % of the second constitutional unit (formula (II)) is 54%, and the wt % of the third constitutional (formula (III)) is 38%.

HC Ex 12 has a number average molecular weight (Mn) of 4500, with q=6, n=35, and m is approximately 3. The value n/(q+m)=3.9 and q/m=2. The weight percent (wt. %) of the first constitutional unit (formula (I)) is 8%, the wt % of the second constitutional unit (formula (II)) is 47%, and the wt % of the third constitutional (formula (III)) is 46%.

### General Procedure for Small Scale Formulation Preparation

Formulate HC Ex 11 and HC Ex 12 with D.E.R. 560 and 2-MI (20% in Dowanol PM) catalyst with an epoxy/hardener stoichiometric ratio of 0.8 (based on the theoretical equivalent weight for SMA-POSS AM0270 of 1278 and theoretical equivalent weight for SMA-POSS AM0265 of 1110). To prepare the varnish, D.E.R. 560 (60 wt % in MEK), SMA modified POSS, and 2-MI were weighed into a 4 oz jar and placed on a shaker until a homogenous mixture was obtained. Samples weights are shown in the Table 11, below. The varnishes were painted onto 1080 glass cloth and cured in the oven at 170° C. for 3 min, after which, the samples were cured at 200° C. for 2 hours.

TABLE 11

| | | ES Ex 11 | | | |
|---|---|---|---|---|---|
| | | Weight | Solution | ES Ex 12 | Solution |
| | | (solids) | Weights | Weight (solids) | Weights |
| | EEW | (g) | (g) | (g) | (g) |
| D.E.R. 560 (60 | 455 | 5.01 | 8.35 | 5.01 | 8.35 |
| wt % in MEK) | | | | | |
| SMA-POSS | 1278 | — | — | 17.28 | 33.88 |
| AM0270 (51 | | | | | |
| wt % in xylene) | | | | | |
| SMA-POSS | 1110 | 14.99 | 27.76 | — | — |
| AM0265 (54 | | | | | |
| wt % in | | | | | |
| xylenes) | | | | | |
| 2-MI (20% in | | 0.06 | 0.3 | 0.06 | 0.3 |
| Dowanol PM) | | | | | |

The Tg, Dk and Df values for ES Ex 11 and ES Ex 12 are shown in Table 12, where the Tg, Dk and Df values are measured according to the procedures discussed above.

TABLE 12

| | ES Ex 12 | ES Ex 11 |
|---|---|---|
| Dk (1 GHz) | 3.4 | 3.4 |
| Df (1 GHz) | 0.006 | 0.006 |
| Tg | 170 | 140 |

1. A hardener compound for curing with an epoxy resin, comprising:
a copolymer having a first constitutional unit of the formula (I): 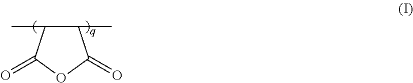
a second constitutional unit of the formula (II): 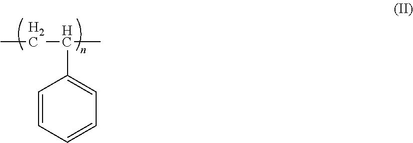
and a third constitutional unit of the formula (III): 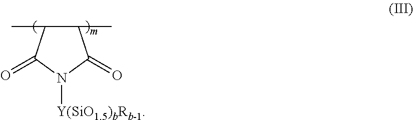
where each q, n and m is independently a positive integer, where the positive integers for q, n and m sum to a value that is from 10 to no greater than 150 and a value of n/(q+m) is from 1 to 10; each b is independently selected from the group of 6, 8, 10 and 12; each Y is independently an organic group; and each R is independently selected from the group of a hydrogen, an organic group and a halogen.

2. The hardener compound of claim 1, where the organic group of each R is independently selected from an aliphatic group, aromatic group, or a cycloaliphatic group.

3. The hardener compound of claim 1, where each Y is independently selected from an alkyl group or an aromatic group.

4. The hardener compound of claim 1, where b is 8, each R is a phenyl group (Ph) and Y is a —C₃H₆— group to provide the hardener compound represented by formula (IV):

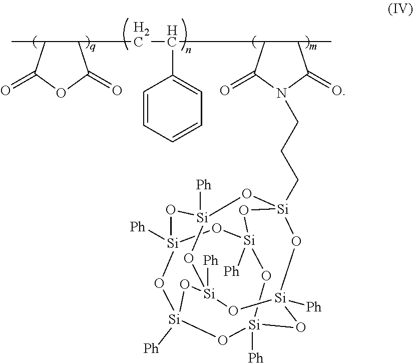

5. The hardener compound of claim 1, where the first constitutional unit (formula (I)) constitutes 0.5 weight percent (wt. %) to 50 wt. % based on a total weight of the hardener compound.

6. The hardener compound of claim 1, where the first constitutional unit (formula (I)) constitutes 5 wt. % to 20 wt. % based on a total weight of the hardener compound.

7. The hardener compound of claim 1, where the third constitutional unit (formula (III)) constitutes 20 wt. % to 90 wt. % based on the total weight of the hardener compound.

8. The hardener compound of claim 1, where the third constitutional unit (formula (III)) constitutes 30 wt. % to 85 wt. % based on the total weight of the hardener compound.

9. The hardener compound of claim 1, where the —Y(SiO_{1.5})_{b}R_{b-1} group of the third constitutional unit (formula (III)) constitutes 5 wt. % to 85 wt. % based on the total weight of the hardener compound.

10. (canceled)

11. The hardener compound of claim 1, where a molar ratio of a combination of the first constitutional unit of the formula (I) and the third constitutional unit of the formula (III) to the second constitutional unit of formula (II) is 1:1 to 1:10.

12. A method of preparing a hardener compound for curing with an epoxy resin, comprising:
reacting a copolymer of styrene and maleic anhydride of the formula (V) 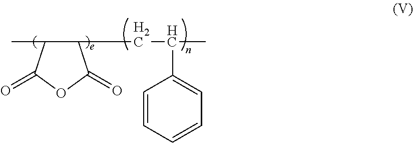
with an amino polyhedral oligomeric silsesquioxane of the formula (VI)
H₂N—Y(SiO_{1.5})_{b}R_{b-1} (VI)
under conditions effective to form the hardener compound of formula (VII): 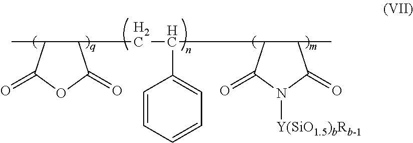
for curing with the epoxy resin, where each q, n and m is independently a positive integer, with e being the sum of q and m, and where the positive integers for q, n and m sum to a value that is from 10 to no greater than 150 and a value of n/(q+m) is from 1 to 10; each b is independently selected from the group of 6, 8, 10 and 12; each Y is independently an organic group; and each R is independently selected from the group of a hydrogen, an organic group and a halogen.

13. The method of claim 12, where reacting the copolymer of styrene and maleic anhydride of the formula (V) with the amino polyhedral oligomeric silsesquioxane of the formula (VI) includes dissolving the copolymer of styrene and maleic anhydride of the formula (V) and the amino polyhedral oligomeric silsesquioxane of the formula (VI) in N,N-dimethyl formamide.

14. The method of claim 12, including precipitating the hardener compound of formula (VII) with a solvent.

15. The method of claim 12, where b is 8, each R is a phenyl group (Ph) and Y is a —C₃H₆— group to provide the copolymer represented by formula (IV):

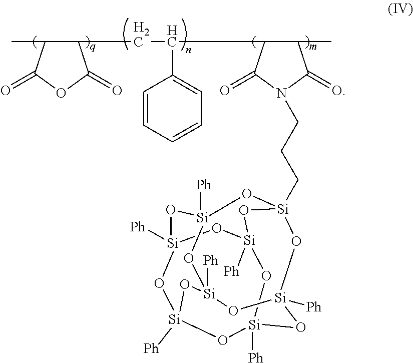

16. The method of claim 12, where the —Y(SiO_{1.5})_{b}R_{b-1} group constitutes 1 wt. % to 85 wt. % based on the total weight of the hardener compound.

17. An epoxy system, comprising:
an epoxy resin; and
a hardener compound of claim 1.

18. The epoxy system of claim 17, wherein the epoxy resin is selected from the group of aromatic epoxy compounds, alicyclic epoxy compounds, aliphatic epoxy compounds, or a combination thereof.

19.-20. (canceled)
